(19) United States
(12) Patent Application Publication
(10) Pub. No.: US 2013/0027683 A1
(43) Pub. Date: Jan. 31, 2013

(54) ELECTRON-BEAM EXPOSURE METHOD AND ELECTRON-BEAM EXPOSURE APPARATUS

(71) Applicant: Hiroshi Yamashita, Shinjuku-ku (JP)

(72) Inventor: Hiroshi Yamashita, Shinjuku-ku (JP)

(73) Assignee: HOYA CORPORATION, Shinjuku-ku, Tokyo (JP)

(21) Appl. No.: 13/635,590

(22) PCT Filed: Mar. 15, 2011
(86) PCT No.: PCT/JP2011/056112

§ 371 Date: Oct. 12, 2012

(30) Foreign Application Priority Data
Mar. 16, 2010 (JP) 2010-059174

(51) Int. Cl. G03B 27/54

(52) U.S. Cl. 355/67; 355/77

(57) ABSTRACT

An effective region of the light-sensitive film to be exposed is divided in a radial direction of the substrate, into at least a first region, and a second region adjacent to the first region and provided at more outer peripheral side of the substrate than the first region, and a third region adjacent to the second region and provided at more outer peripheral side of the substrate than the second region, and the rotational speed of the substrate is varied during electron beam exposure of the second region, under a condition that the linear speed of the substrate is kept to be constant at the irradiation position of the electron beam; and the rotational speed of the substrate is varied during electron beam exposure of the first region and the third region, under a condition that the linear speed of the substrate is set to be slower respectively than the linear speed used in the second region.

### TECHNICAL FIELD

The present invention relates to an electron-beam exposure method and an electron-beam exposure apparatus.

### BACKGROUND ART

For example, as a technology of manufacturing a disc-shaped substrate (master disc, stamper, and the like) used for DTR technology (Discrete Track Recording), there has been known a technology in which a light-sensitive film formed on a substrate is irradiated by an electron beam to expose the light-sensitive film (hereinafter also referred to as “electron-beam exposure technology”).

Also, as an electron-beam exposure apparatus used for the electron-beam exposure technology, there has been an apparatus including a stage referred to as “r-θ system”, which includes both a function of rotating the substrate to be exposed and a function of moving the substrate (for example, see patent document 1 and patent document 2). While the electron-beam irradiation apparatus of this type is configured to rotate the substrate by the aforementioned stage, the apparatus is configured to move the substrate in the radial direction of the substrate to irradiate the light-sensitive film on the substrate with an electron beam.

At this time, when the substrate is rotated at constant speed, a linear speed of the substrate at an irradiation position of the electron beam is different in a radial direction of the substrate (particularly on an inner peripheral side and an outer peripheral side of the substrate) Specifically the linear speed is different according to a difference of distances from a rotation center of the substrate to the irradiation position of the electron beam, and more specifically the linear speed of the substrate becomes relatively slower on the inner peripheral side of the substrate where the distance to the irradiation position is short, and becomes relatively faster on the outer peripheral side of the substrate where the distance to the irradiation position is long. The “linear speed of the substrate” mentioned here means the speed (peripheral speed) required for the electron beam to trace the plane of the substrate (more strictly, a light-sensitive film on the substrate), at an irradiation position of the electron beam.

In the case of exposure, a beam current (Ib, A) is normally fixed. An amount of electric charge per unit length applied to the light-sensitive film (an amount of electron beam exposure uC/cm) is expressed by a value (Ib/v) obtained by dividing a beam current by the linear speed (v, cm/s). Accordingly, the aforementioned difference of the linear speed of the substrate leads to a difference of the exposure energy amount applied to the light-sensitive film by the incidence of the electron beam. That is, the exposure energy amount applied to the light-sensitive film is relatively large on the inner peripheral side of the substrate where the linear speed of the substrate is relatively low, and the exposure energy amount applied to the light-sensitive film is relatively small on the outer peripheral side of the substrate where the linear speed of the substrate is relatively high.

Therefore, conventionally, the rotational speed of the substrate is controlled in such a manner that the linear speed of the substrate at the irradiation position of the electron beam, that is, the amount of exposure by beams, is kept to be constant. Specifically, when the irradiation position of the electron beam is on the inner peripheral side of the substrate, the rotational speed of the substrate is controlled to relatively be increased. When the irradiation position of the electron beam is on the outer peripheral side of the substrate, the rotational speed of the substrate is controlled to relatively be decreased. Also, in the radial direction of the substrate, for example, when the irradiation position of the electron beam is sequentially moved from the inner peripheral side to the outer peripheral side of the substrate, the rotational speed of the substrate is controlled to gradually be reduced in accordance with the movement.

Incidentally, electrons incident on one point of the light-sensitive film on the substrate collide with constituent atoms of the light-sensitive film and scattered and expanded. In this case, the distribution of exposure intensity in the vicinity of the incident point is similar to a Gaussian distribution whose peak is the incident point. Also, the electrons passed through the light-sensitive film and incident on the substrate collide with the constituent atoms of the substrate and scattered, and part of the electrons is incident on the light-sensitive film again as backward scattered electrons. The former phenomenon is referred to as “forward scattering”, and the latter phenomenon is referred to as “backward scattering”.

When the electrons spread by the forward scattering or the backward scattering, the exposure energy is applied to other portions of the light-sensitive film on the substrate other than the incident point of the electron beam. In this case, there occurs a phenomenon that is characteristic of the electron-beam exposure, which is referred to as “proximity effect”. The proximity effect is the effect of simultaneously accumulating energy not only at the incident point of the electron beam, but also in a region close to the incident point. Reversely, it can be said that the exposure energy at the incident point receives contribution of the energy from other incident point.

Generally, when the resist film has a thin film thickness, such as several tens of nanometers, the expansion diameter of the electron beam by the forward scattering (hereinafter referred to as “diameter of forward scattering”) at a high acceleration voltage (to the extent of 50 to 100 kV) is small, which is approximately several nanometers, compared with the beam diameter of the incident electron beam. However, the expansion diameter of the electron beam by the backward scattering (hereinafter referred to as “diameter of backward scattering”) is larger by three digits than the beam diameter of the incident electron beam. For example, on the condition that the acceleration voltage is 50 kV and when the beam diameter of the incident electron beam is approximately several nanometers, the diameter of the backward scattering is approximately 10 μm.

Accordingly, when the light-sensitive film on the substrate is exposed using the electron-beam irradiation apparatus including the aforementioned “r-θ system” stage, there occurs variation in dimensions of patterns due to the influence of the proximity effect by the backward scattered electrons on the inner peripheral side and the outer peripheral side of the substrate, even if the linear speed of the substrate is kept to be constant. In DTR, whereas dimensions of a drawing target are approximately several tens of nanometers, which is smaller by one digit than the diameter of the forward scattering, a drawing area reaches several tens of millimeters, and in particular, the drawing dimensions are greatly affected by the proximity effect by the backward scattering. A correction technology regarding the proximity effect has already been practically used in the field of the semiconductor manufacturing technology in which an electron beam lithography apparatus including an XY stage is used, specifically, for the direct drawing on a wafer and mask drawing. As a method of obtaining the proximity effect by the backward scattering, there has been used an area density method by which drawing patterns are divided into meshes smaller than the diameter of the backward scattering, and the area density of patterns included in the mesh is used (for example, patent document 3, patent document 4, and patent document 5). Based on its results, a correction method of adjusting the amount of exposure on each shot has been usually used. Also, a correction technology based on the adjustment of the dimensions of mask has been known as described in patent document 6.

### RELATED ART DOCUMENTS

### Patent Documents

[Patent Document 1] Japanese Unexamined Patent Application Publication No. 2000-11464.

[Patent Document 2] Japanese Unexamined Patent Application Publication No. 2009-15910.

[Patent Document 3] Japanese Unexamined Patent Application Publication No. 1983-32420.

[Patent Document 4] Japanese Unexamined Patent Application Publication No. 1984-139625.

[Patent Document 5] Japanese Unexamined Patent Application Publication No. 1983-284921.

[Patent Document 6] Japanese Unexamined Patent Application Publication No. 2006-222230.

### DISCLOSURE OF THE INVENTION

### Problems to be Solved by the Invention

A main object of the present invention is to provide a technique capable of suppressing a variation of pattern dimensions caused by an proximity effect, when performing electron beam exposure operation by rotating and moving a substrate on which a light-sensitive film is formed.

### Means of Solving the Problems

A first embodiment of the present invention may include an electron-beam exposure method when a light-sensitive film of a substrate is exposed to irradiation of an electron beam by rotating the substrate on one main plane on which the light-sensitive film is formed and by moving an irradiation position of the electron beam on one main plane of the substrate in a direction parallel to a radial direction of the substrate, the method includes the steps of, in a region where an amount of exposure is larger than a prescribed amount of exposure when the exposure is carried out on a condition that a linear speed of the substrate at the irradiation position of the electron beam is kept to be constant while a rotational speed of the substrate is varied, varying the rotational speed of the substrate in such a manner that the linear speed of the substrate increases, compared with a case where the exposure is carried out on the condition that the linear speed of the substrate at the irradiation position of the electron beam is kept to be constant while the rotational speed of the substrate is varied, and in a region where an amount of exposure is smaller than a prescribed amount of exposure when the exposure is carried out on the condition that the linear speed of the substrate at the irradiation position of the electron beam is kept to be constant while the rotational speed of the substrate is varied, varying the rotational speed of the substrate in such a manner that the linear speed of the substrate decreases, compared with the case where the exposure is performed under the condition that the linear speed of the substrate at the irradiation position of the electron beam is kept to be constant while the rotational speed of the substrate is varied.

A second embodiment of the present invention may be such that an electron-beam exposure apparatus includes, rotating means configured to rotate a substrate while supporting the substrate, on one main plane on which a light-sensitive film is formed, moving means configured to move an irradiation position of an electron beam on the one main plane of the substrate supported by the rotating means in a direction parallel to a radial direction of the substrate; and rotation controlling means configured to control a drive of the rotating means, wherein the rotation controlling means is configured to control the drive of the rotating means in a manner that in a region where an amount of exposure is more increased than a prescribed amount of exposure when the exposure is carried out under a condition that a linear speed of the substrate at the irradiation position of the electron beam is kept to be constant while a rotational speed of the substrate is varied, the rotational speed of the substrate is varied in such a manner that the linear speed of the substrate increases, compared with a case where the exposure is performed under the condition that the linear speed of the substrate at the irradiation position of the electron beam is kept to be constant while the rotational speed of the substrate is varied, and in a region where an amount of exposure is more reduced than a prescribed amount of exposure when the exposure is performed under on the condition that the linear speed of the substrate at the irradiation position of the electron beam is kept to be constant while the rotational speed of the substrate is varied, the rotational speed of the substrate is varied in such a manner that the linear speed of the substrate decreases, compared with the case where the exposure is performed under the condition that the linear speed of the substrate at the irradiation position of the electron beam is kept to be constant while the rotational speed of the substrate is varied.

### Effects of the Invention

According to the present invention, when a substrate on which a light-sensitive film is formed is exposed to an electron beam while being rotated and moved, variation in dimensions of patterns due to a proximity effect can be suppressed.

### BRIEF DESCRIPTION OF THE DRAWINGS

FIG. 1 is a schematic view of configuration of an electron-beam exposure apparatus according to an embodiment of the present invention.

FIG. 2 are diagrams illustrating a structure of a substrate to be exposed according to the embodiment of the present invention.

FIG. 3 is a diagram illustrating a situation when electron-beam exposure is carried out.

FIG. 4 is a graph describing a method adopted in the embodiment of the present invention.

FIG. 5 is a diagram illustrating one example of patterns obtained after exposure and development.

FIG. 6 is a diagram describing a correction principle of proximity effect (part 1).

FIG. 7 is a graph describing the correction principle of proximity effect (part 2).

FIG. 8 is a graph illustrating variation in exposure intensity by backward scattering.

### MODE FOR CARRYING OUT THE INVENTION

Hereinafter, concrete embodiments of the present invention will be described in detail by referring to the drawings. In the embodiments of the present invention, description will be given in the following order.
1. Basic Configuration of Electron-beam Exposure Apparatus (Configuration of Mechanical System, Configuration of Control System)
2. Structure of Substrate
3. Basic Operation of Electron-beam Exposure Apparatus
4. Control Method of Electron-beam Exposure Apparatus (Including Electron-beam Exposure Method)
5. Effect of Embodiments
6. Other Embodiments

### 1. Basic Configuration of Electron-Beam Exposure Apparatus

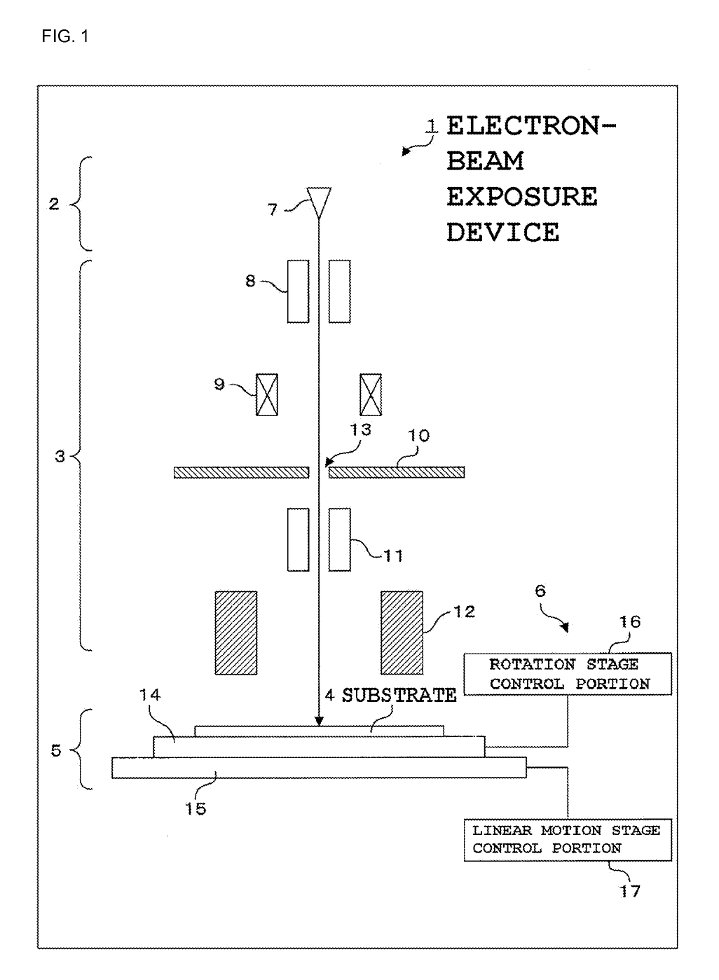

FIG. 1 shows a schematic view illustrating the configuration of an electron-beam exposure apparatus according to the embodiment of the present invention. An electron-beam exposure apparatus 1 shown is mainly constituted of an electron-beam generating portion 2 to generate an electron beam, an electron-beam control system 3 to control the electron beam generated by the electron-beam generating portion 2, a stage mechanism 5 to support a substrate 4 that is a target of exposure, and a stage control system 6 to control the drive of the stage mechanism 5.

### (Electron-Beam Generating Portion)

The electron-beam generating portion 2 is constituted by an electron gun 7 that is a source of electron beams. The electron gun 7 is arranged in a state opposite to the substrate 4 supported by the stage mechanism 5. In the diagram, the electron gun 7 is configured to downwardly emit the electron beam.

### (Electron-Beam Control System)

For example, as is shown in the diagram, the electron-beam control system 3 includes blanking electrodes 8, converging lenses 9, an aperture 10, deflectors 11, and object lenses 12.

The blanking electrodes 8 control an advance of the electron beam on the downstream side. When the blanking is carried out, the blanking electrodes 8 deflect the axis of the electron beam by an electric field in a manner that the electron beam is blocked by the aperture 10, and when the blanking is not carried out, the blanking electrodes 8 allow the electron beam to pass through an opening portion 13 of the aperture 10. In this example, the blanking electrodes 8 are arranged between the electron gun 7 and the converging lenses 9 on a orbit of the electron beam leading from the electron gun 7 to the substrate 4.

The converging lenses 9 converge the electron beam emitted from the electron gun 7. The converging lenses 9 are arranged between the blanking electrodes 8 and the aperture 10 on the orbit of the electron beam leading from the electron gun 7 to the substrate 4.

The aperture 10 serves as a function of blocking an unnecessary electron beam in order to selectively carry out the irradiation of the electron beam to a light-sensitive film when the light-sensitive film is irradiated by the electron beam. The aperture 10 integrally includes the opening portion 13 for the electron beam to pass through. The aperture 10 is arranged between the converging lenses 9 and the deflectors 11 on the orbit of the electron beam leading from the electron gun 7 to the substrate 4.

The deflectors 11 vary the direction (traveling direction) of the electron beam that is passed through the opening portion 13 of the aperture 10 so as to vary the irradiation position of the electron beam on the substrate. At least two deflectors or more are provided in the X direction and the Y direction. The deflectors 11 are arranged between the aperture 10 and the object lenses 12 on the orbit of the electron beam leading from the electron gun 7 to the substrate 4.

The object lenses 12 narrow the diameter of the beam in such a manner that the focus of the electron beam passing through the opening portion 13 of the aperture 10 is adjusted to an upper plane of the substrate 4, that is, the light-sensitive film. The object lenses 12 are arranged between the deflectors 11 and the stage mechanism 5 on the orbit of the electron beam leading from the electron gun 7 to the substrate 4. In addition, a dynamic focus lens (not shown) is provided that measures the variation in height of the substrate, which is caused by the rotation of the warped substrate, and corrects the focus on the real time basis.

### (Stage Mechanism)

The stage mechanism 5 is constituted by a rotation stage 14 and a linear motion stage 15. The aforementioned r-θ system stage is constituted by the rotation stage 14 and the linear motion stage 15.

The rotation stage 14 horizontally supports the substrate 4 and allows the substrate 4 supported to rotate. For example, the rotation stage 14 is configured to rotate, by a driving source such as a spindle motor not shown. The rotation stage 14 is provided as one example of a rotation means for supporting the substrate 4 and rotating the substrate 4.

The linear motion stage 15 linearly moves in an axial direction parallel to the horizontal plane (hereinafter referred to as “horizontal direction”). The linear motion stage 15 integrally moves with the rotation stage 14 and the substrate 4 held by the rotation stage 14 in the horizontal direction. The linear motion stage 15 is provided as one example of a moving means for moving the substrate 4 held by the rotation stage 14 in a direction parallel to the radial direction of the substrate 4.

### (Stage Control System)

The stage control system 6 includes a rotation stage control portion 16 to control the rotation stage 14 and a linear motion stage control portion 17 to control the linear motion stage 15.

The rotation stage control portion 16 controls the drive of the rotation stage 14. More specifically, the rotation stage control portion 16, for example, carries out the control of the rotational speed and the rotational direction of the rotation stage 14, in addition to the basic operations such as the rotation and stoppage of the rotation stage 14. The rotational speed of the rotation stage 14 described herein is represented by the number of rotations per unit time (unit time; rpm). The rotation stage control portion 16 recognizes a present position (rotational phase) regarding the rotational direction of the rotation stage 14, for example, by a rotational position detecting sensor not shown and provided in the electron-beam exposure apparatus 1. Regularly, the rotation stage control portion 16 includes a function of correcting jitters (rotational unevenness) based on the output of the rotational position detecting sensor.

The linear motion stage control portion 17 controls the drive of the linear motion stage 15. More specifically, the linear motion stage control portion 17 carries out the control of the moving direction and the moving speed of the linear motion stage 15, in addition to the basic operations such as the movement and stoppage of the linear motion stage 15. The linear motion stage control portion 17 recognizes a present position in the moving direction of the linear motion stage 15, for example, by a moving position detecting sensor not shown and provided in the electron-beam exposure apparatus 1. Regularly, the linear motion stage control portion 17 includes a function of correcting a beam irradiation position by feeding back deflection (a difference between a command value and a measured position) into a beam deflector based on the output of the moving position detecting sensor.

### 2. Structure of Substrate

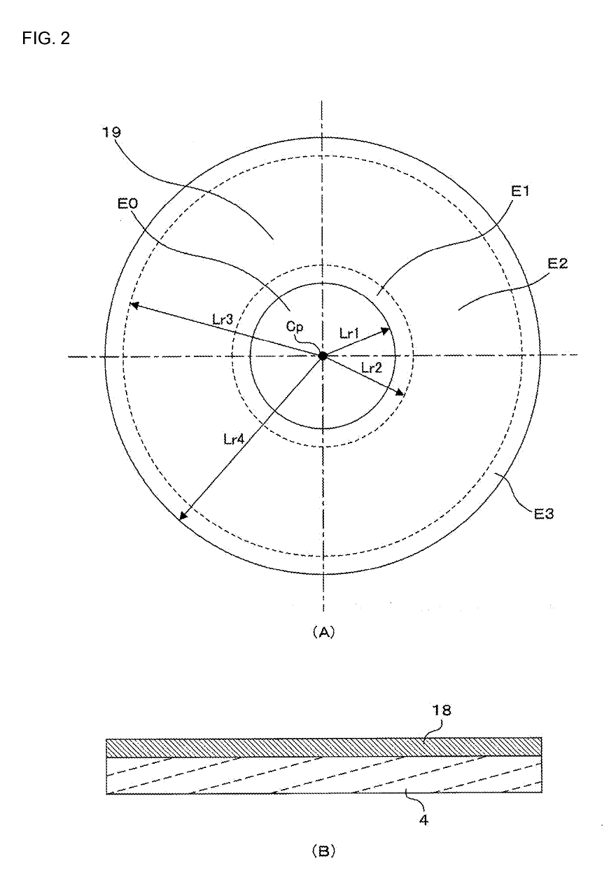

FIG. 2 are diagrams illustrating the configuration of a substrate that is a target of exposure according to an embodiment of the present invention, and FIG. 2A in the diagram shows a plan view, and FIG. 2B in the diagram shows a side cross-sectional view.

For example, the substrate 4 is constituted by a silica glass substrate. The plane shape of the substrate 4 is circularly formed. A resist film 18 is formed on one main plane (upper plane) of the substrate 4 as one example of the light-sensitive film. Also, there is a case where, on the substrate 4, a thin metal film is formed that serves as a hard mask when the quartz is etched. Any of a positive type resist and a negative type resist may be applied to the resist film 18 to be formed.

When the positive type resist is used, a region exposed to the irradiation of the electron beam is removed by the following development process. When the negative type resist is used, the region exposed to the irradiation of the electron beam is not removed but left after development. In the present embodiment, the positive type resist is used to form the resist film 18.

Regarding the substrate 4, part of the region (film formation region) where the resist film 18 is formed becomes a target of exposure. Incidentally, as one example, a physical center Cp of the substrate 4 serves as a reference, and except for a circular region E0 whose radius is a length Lr1 extended from the center Cp in the radial direction of the substrate 4, a region on the outer side of the circular region E0 is set as an effective region (exposure target region) 19 of the resist film 18.

The effective region 19 of the resist film 18 described herein is a region where resist patterns are formed by the development process carried out after the electron-beam exposure. Accordingly, when disc-shaped recording media are manufactured using a master disc based on patterns obtained through the electron-beam exposure and the following development process, the effective region of the resist film 18 is, for example, a region (region required to maintain the quality of products) corresponding to the region where the disc plane of the recording media is transferred.

In the one main plane of the substrate 4, the effective region 19 of the resist film 18 is hypothetically divided into three regions as a target region where “linear speed of substrate” (the definition of the term has been described above) regarding the irradiation position of the electron beam is individually set. In the specification, these three regions are described as a first region E1, a second region E2, and a third region E3.

Out of the three regions, the first region E1 is a doughnut-shaped region whose range is defined by a length Lr1 and a length Lr2 at the center Cp of the substrate 4 as a reference in the radial direction of the substrate 4. The first region E1 is positioned on the outer peripheral side (outer side) of the substrate 4 with respect to the circular region E0.

The second region E2 is a doughnut-shaped region whose range is defined by the length Lr2 and a length Lr3 at the center Cp of the substrate 4 as a reference in the radial direction of the substrate 4. The second region E2 is positioned on the outer peripheral side (outer side) of the substrate 4 with respect to the first region E1.

The third region E3 is a doughnut-shaped region whose range is defined by the length Lr3 and a length Lr4 at the center Cp of the substrate 4 as a reference in the radial direction of the substrate 4. The third region E3 is positioned on the outer peripheral side (outer side) of the substrate 4 with respect to the second region E2.

An outer peripheral edge of the circular region E0 and an inner peripheral edge of the first region E1 are defined by a common circle whose radius is the length Lr1 from the center Cp of the substrate 4. Accordingly, the circular region E0 and the first region E1 are positioned adjacent to each other in the radial direction of the substrate 4.

Similarly, the outer peripheral edge of the first region E1 and an inner peripheral edge of the second region E2 are defined by a common circle whose radius is the length Lr2 from the center Cp of the substrate 4. Accordingly, the first region E1 and the second region E2 are positioned adjacent to each other in the radial direction of the substrate 4.

Also, an outer peripheral edge of the second region E2 and an inner peripheral edge of the third region E3 are defined by a common circle whose radius is the length Lr3 from the center Cp of the substrate 4. Accordingly, the second region E2 and the third region E3 are positioned adjacent to each other in the radial direction of the substrate 4.

Also, the length Lr4 specified by the center Cp of the substrate 4 as a reference corresponds to the radius of the substrate 4. Accordingly, the outer peripheral edge of the third region E3 corresponds with an outer peripheral edge of the substrate 4. However, normally, since the dimensions of the exposure target region are smaller than the dimensions (outer diameter) of the substrate 4, the outer peripheral edge of the third region E3 does not correspond with the outer peripheral edge of the substrate 4.

Further, the first region E1 is specified by a dimension corresponding to the diameter of backward scattering of the electron beam described later, from the inner peripheral edge of the effective region 19 of the resist film 18 (a circle specified by the radius of the length Lr1). Also, the third region E3 is specified by a dimension corresponding to the diameter of backward scattering of the electron beam described later, from the outer peripheral edge of the effective region 19 of the resist film 18 (a circle specified by the radius of the length Lr4).

Incidentally, exposure intensity distribution in the case where the electron beam is irradiated to one point of the resist can be approximated by the following formula with an EID (Exposure Intensity Distribution) function f(r) in which a distance from a point of incidence of the electron beam is defined by r. When the intensity distribution of a point (also referred to as spot or Gaussian) beam is regarded as Gaussian distribution, a diameter of forward scattering βf may be respective square root of sum squares. It is noted that the amount of energy accumulated in the resist through actual exposure bears a proportional relationship to exposure intensity.

$$f ( r ) = \frac{1}{π {β}_{f}^{2} ( 1 + η )} \{ exp ( \frac{- {r}^{2}}{{β}_{f}^{2}} ) + η \frac{{β}_{f}^{2}}{{β}_{b}^{2}} exp ( \frac{- {r}^{2}}{{β}_{b}^{2}} ) \} \qquad [ Formula 1 ]$$

In this case, regarding the first region E1, it is preferable that the first region E1 be specified by a dimension of 0.7 to 1.5 times of the diameter of backward scattering βb (preferably, 1.0 to 1.5 times, more preferably, 1.5 times), from the inner peripheral edge of the effective region 19 of the resist film 18 (a circle specified by the radius of the length Lr1). Similarly, regarding the third region E3, it is preferable that the third region E3 be specified by a dimension of 0.7 to 1.5 times of the diameter of backward scattering βb (preferably, 1.0 to 1.5 times, more preferably, 1.5 times), from the outer peripheral edge of the effective region 19 of the resist film 18 (the circle specified by the radius of the length Lr4). Accordingly, for example, when the diameter of backward scattering of the electron beam is 10 μm, it is preferable that the first region E1 be specified by a dimension of 7 to 15 μm (preferably, 10 to 15 μm, more preferably, 15 μm), from the inner peripheral edge of the effective region 19 of the resist film 18 to the outer peripheral edge of the substrate 4. Similarly, it is preferable that the third region E3 be specified by a dimension of 7 to 15 μm (preferably, 10 to 15 μm, more preferably, 15 μm), from the outer peripheral edge of the effective region 19 of the resist film 18 to the inner peripheral edge of the substrate 4.

### 3. Basic Operation of Electron-Beam Exposure Apparatus

Next, a basic operation of electron-beam exposure apparatus 1 according to the embodiments of the present invention will be described.

First, the substrate 4 is mounted and secured on the rotation stage 14. In this time, the substrate 4 is positioned in a manner that the rotational center of the rotation stage 14 corresponds with the physical center Cp of the substrate 4 as much as possible. Also, the substrate 4 is horizontally arranged in a manner that the resist film 18 is upwardly directed (in a manner that the resist film 18 is disposed opposite to the electron gun 7).

Next, an initialization process set in advance (for example, a process to detect a reference position in the rotational direction of the rotation stage 14, and a process to detect a reference position in the moving direction of the linear motion stage 15) is carried out as needed. For example, each reference position is detected by the aforementioned rotational position detecting sensor and moving position detecting sensor.

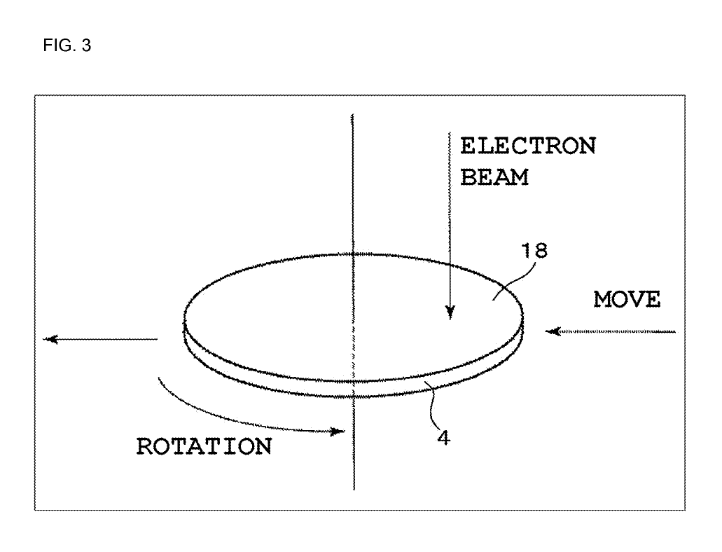

Next, the substrate 4 supported by the rotation stage 14 is moved by the linear motion stage 15 to a point nearest to an exposure start radius position, and the substrate 4 is rotated by the drive of the rotation stage 14 at the point. Then, when the rotational speed of the substrate 4 is stabilized at a prescribed speed, and the beam irradiation position on the substrate 14 reaches the exposure start radius position, the electron-beam exposure is started. The situation at this case is shown in FIG. 3.

Concerning the electron-beam exposure, the irradiation of the electron beam emitted from the electron gun 7 is controlled by the blanking electrodes 8 and converged by the converging lenses 9 so as to allow the electron beam to pass through the opening portion 13 of the aperture 10. Further, the direction of the electron beam passed through the aperture 10 is controlled by the deflectors 11 and the beam diameter of the electron beam is narrowed by the object lenses 12.

Accordingly, the resist film 18 formed on the substrate 4 is concentrically exposed to the rotational drive of the rotation stage 14. Also, the drive of the linear motion stage 15 allows the substrate 4 to move (slightly move) in the horizontal direction, and the concentric exposure is repeated for every one rotation of the substrate 4 in accordance with the movement so as to expose the whole of the effective region 19 of the resist film 18. However, when the concentric exposure is carried out in a time during which the substrate 4 makes one rotation, it is configured to control in such a manner that the irradiation of the electron beam is switched on and off in accordance with the desired drawing pattern. This switching is implemented by the blanking electrodes 8. Also, the displacement (horizontal displacement) of the substrate 4 in the radial direction by the linear motion stage 15 may be successive displacement or step displacement. In the case of the successive displacement, it is necessary to correct the beam position by the deflectors 11 in synchronism with the rotation in such a manner as to carry out the concentric exposure described above. This is because the resist film 18 is exposed in a spiral shape if the beam position is not corrected.

### 4. Control Method of Electron-Beam Exposure Apparatus (Including Electron-Beam Exposure Method)

Next, control method of the electron-beam exposure apparatus 1 will be described, which includes an electron-beam exposure method according to the embodiments of the present invention.

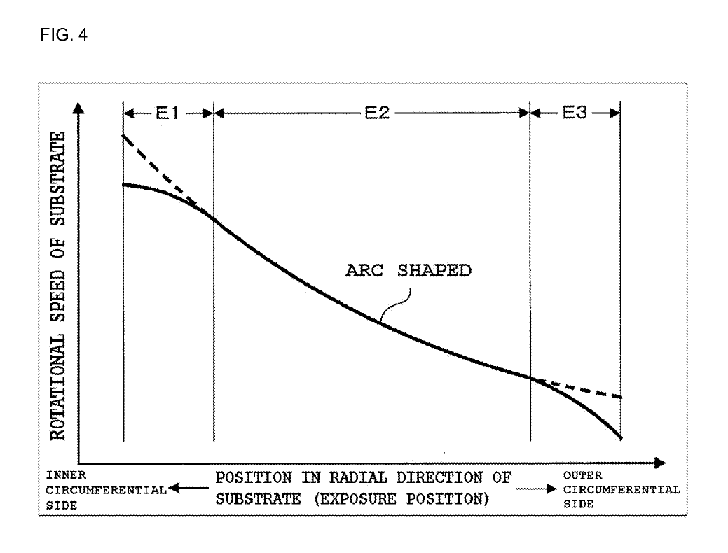

The electron-beam exposure is carried out while the substrate 4 is rotated by the drive of the rotation stage 14 as described above. In this time, the rotation stage control portion 16 controls the drive of the rotation stage 14, for example, based on the conditions shown in FIG. 4. It is noted that, as shown in FIG. 4, a longitudinal axis of the graph shows the rotational speed of the substrate 4, and a lateral axis shows a position (exposure position) in the radial direction of the substrate 4. The rotational speed of the rotation stage 14 serves as a control parameter to determine a rotational speed n (n=v÷r) that is represented by a speed v and a radius r of a circle.

As is evident in FIG. 4, in a period when the second region E2 is exposed, the rotation stage control portion 16 controls the drive of the rotation stage 14 in such a manner that the rotational speed of the substrate 4 is varied based on the condition where the linear speed (rotational speed n) of the substrate 4 at the irradiation position of the electron beam is kept constant. In contrast, in a period when the first region E1 and the third region E3 are each exposed, the rotation stage control portion 16 controls the drive of the rotation stage 14 in such a manner that the rotational speed of the substrate 4 is varied based on the condition where each linear speed is lower than the linear speed of the substrate 4 that is applied in the second region E2.

More specifically, in the period when the second region E2 is exposed, the rotation stage control portion 16 varies the rotational speed of the substrate 4 as shown in an arc-shaped curve (v/r) in the graph in such a manner that the linear speed of the substrate 4 at the irradiation position of the electron beam is kept constant, irrespective of the difference of the irradiation position.

Also, in the period when the first region E1 and the third region E3 are each exposed, the rotation stage control portion 16 controls the drive of the rotation stage 14 in such a manner that the rotational speed of the substrate 4 is varied along each curve that is different from a curve of the rotational speed of the substrate 4 that is applied in the second region E2.

Specifically, in the period when the first region E1 is exposed, the rotation stage control portion 16 controls the drive of the rotation stage 14 in such a manner that the rotational speed is lower than the rotational speed of the substrate 4 that is applied in the second region E2.

In FIG. 4, a dotted line illustrated in the first region E1 shows a rotational speed in the case where the rotational speed of the substrate 4 that is applied in the second region E2 is applied in the first region E1 without variation in such a manner as to keep the linear speed constant. With respect to the rotational speed shown in the dotted line, the rotational speed of the substrate 4 that is actually applied in the first region E1 is relatively low as shown in the curve in the graph. This is obvious in that the gradient of the curve in the graph is smaller than that of the dotted line in the graph in the first region E1.

Also, in the period when the third region E3 is exposed, the rotation stage control portion 16 controls the drive of the rotation stage 14 in such a manner that the rotational speed is lower than the rotational speed of the substrate 4 that is applied in the second region E2.

In FIG. 4, a dotted line illustrated in the third region E3 shows the variation of a rotational speed in the case where the variation of the rotational speed of the substrate 4 that is applied in the second region E2 is applied in the third region E3 without variation in such a manner as to keep the linear speed constant. With respect to the rotational speed shown in the dotted line, the rotational speed of the substrate 4 that is actually applied in the third region E3 is relatively low as shown in the curve in the graph.

Also, in the first region E1 and the third region E3, each curve showing the variation of the rotational speed of the substrate 4 is illustrated in an arched shape. Then, in the first region E1, the closer the curve comes to the inner peripheral edge of the first region E1, the wider the rotational speed difference between the first region E1 and the second region E2 becomes. Also, in the third region E3, the closer the curve comes to the outer peripheral edge of the third region E3, the wider the rotational speed difference between the second region E2 and the third region E3 becomes. That is, a variation ratio of the rotational speed of the substrate 4 in the case where the irradiation position of the electron beam is displaced in a direction parallel to the radial direction of the substrate 4 (for example, to the outer peripheral side from the inner peripheral side of the substrate 4) in the first region E1 and the third region E3 is different from a variation ratio of the rotational speed of the substrate 4 in the second region E2. Specifically, in the period when the first region E1 is exposed while the irradiation position of the electron beam is displaced as described above, the rotational speed of the substrate 4 is varied with a variation ratio smaller than a variation ratio of the rotational speed of the substrate 4 that is applied in the second region E2. Conversely, in the period when the third region E3 is exposed while the irradiation position of the electron beam is displaced as described above, the rotational speed of the substrate 4 is varied with a variation ratio larger than the variation ratio of the rotational speed of the substrate 4 that is applied in the second region E2. It is noted that “variation ratio of rotational speed” is referred to as a ratio of variation of the rotational speed of the substrate 4 in the case where the irradiation position of the electron beam is displaced in a direction parallel to the radial direction of the substrate 4 in each region described above (E1 to E3).

In the first region E1 and the third region E3, a solid line showing each variation of the rotational speed of the substrate 4 is illustrated in the arched shape but is not limited to this. In the first region E1 and the third region E3, it may be controlled such that the rotational speed of the substrate 4 is each varied at a constant ratio (that is, the solid line in the graph is represented not by the arched shape but by the straight line when an attention is paid to only the first region E1 or only the third region E3).

Also, in the first region E1 and the third region E3, regarding how many percentages of the rotational speed of the substrate 4 is each varied, compared with the second region E2, for example, more preferably, this should be determined based on a simulation and experiment in advance, desirably on the simulation or the results of the experiment.

### 5. Effect of Embodiments

When an electron-beam exposure method based on the aforementioned control method is applied, three regions that divide the effective region 19 of the resist film 18 are represented as follows in comparison with “linear speed of substrate” (the definition of the term has been described above) with respect to the irradiation position of the electron beam.

That is, the linear speed of the substrate in the case where the first region E1 is exposed is lower than the linear speed of the substrate in the case where the second region E2 is exposed. Also, the linear speed of the substrate in the case where the third region E3 is exposed is lower than the linear speed of the substrate in the case where the second region E2 is exposed.

First, when an incident beam current is constant, and the rotational speed of the substrate 4 is varied at a constant ratio in such a manner that the linear speed of the substrate is kept constant in all the three regions that divide the effective region 19 of the resist film 18, the amount of energy provided (accumulated) by exposure to each resist film 18 in the first region E1 and the third region E3 is less than the amount of energy provided to the resist film 18 in the second region E2 due to the influence of backward scattering. Hereinafter, the amount of energy provided to the resist is referred to as an energy accumulation amount. In this time, a difference between the energy accumulation amount of each resist film 18 in the first region E1 and the third region E3 and the energy accumulation amount of the resist film 18 the second region E2 is represented as “α1”.

Next, similarly, when a current of the electron beam incident on the resist film 18 of the substrate 4 is constant, and the linear speed of the substrate in the case where the first region E1 and the third region E3 are exposed is set lower than the linear speed of the substrate in the case where the second region E2 is exposed, the energy accumulation amount of the resist film 18 in the first region E1 and the third region E3 in terms of portions that are targets of exposure is larger than the energy accumulation amount of the resist film 18 in the second region E2, compared with the case where the entire regions are exposed at the same linear speed. In this time, a difference between the energy accumulation amount of each resist film 18 in the first region E1 and the third region E3 and the energy accumulation amount of the resist film 18 in the second region E2 is represented as “α2”.

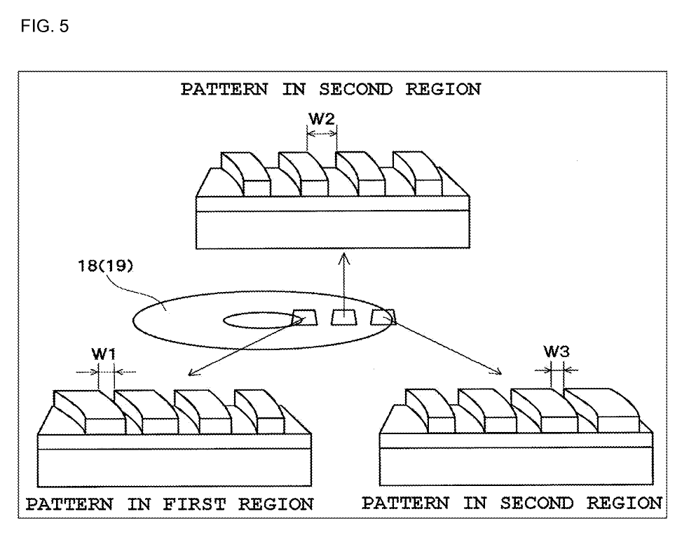

FIG. 5 shows dimensions of patterns obtained in the development process after exposure in the case where the rotational speed of the substrate 4 is varied in such a manner that the linear speed of the substrate is kept constant in all the three regions that divide the effective region 19 of the resist film 18. As is evident in the diagram, although the width of groove of each pattern is made up of a uniform width (W2) in the second region E2 where the energy accumulation amount is relatively great, the width of groove of each pattern is each formed in a manner as to contract in width gradually toward the end of the regions (W1 is approximately equal to W3<W2) in the first region E1 and the third region E3 where the energy accumulation amount is relatively small.

In the embodiment of the present invention, the difference al of the energy accumulation amount generated in the case where the linear speed of the substrate is kept constant in the whole of the effective region 19 of the resist film 18 is cancelled (preferably, completely cancelled out) by the aforementioned difference α2 of the energy accumulation amount so as to correct the reciprocal proximity effect due to the backward scattering. Hereinafter, the principle of correction will be described in detail.

### (Correction Principle of Reciprocal Proximity Effect)

First, on the presupposition of the description, the influence exerted on the energy accumulation amount due to the forward scattering and the backward scattering (in particular, backward scattering) is extended to a peripheral region adjacent to an incident point of the electron beam due to the expansion of scattered electrons in the constitutional member of the substrate 4 and the resist film 18. Then, the expansion depends on the energy of the incident electron beam, and its intensity depends on the number of scattered electrons incident on the resist film 18 (hereinafter referred to as “scattered electron incident number”). However, the energy of the electron beam is determined by the acceleration voltage of the exposure apparatus, and may normally be considered constant.

Also, as is described above, the diameter of the forward scattering is sufficiently small with respect to the beam diameter of the electron beam incident on the substrate 4, but the diameter of the backward scattering is large to the extent of three digits. Accordingly, in particular, when the influence on the exposure of the backward scattering electron is diminished, the improvement of precision of the patterns obtained by the development after exposure can substantially be achieved.

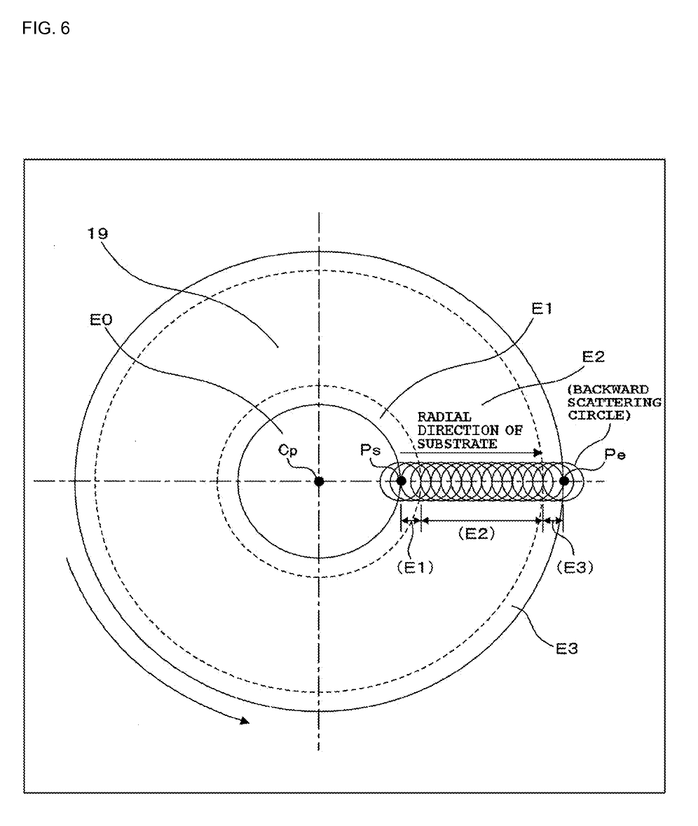

Incidentally, as shown in FIG. 6, in view of the track of a circle, when the circle illustrated in a dimension corresponding to the diameter of the backward scattering (hereinafter referred to as “backward scattering circle”) is displaced in the radial direction of the substrate 4, the center of the backward scattering circle positioned nearest to the end (both ends) of the substrate 4 in the radial direction becomes a start point Ps and a finish point Pe of the effective electron-beam exposure in exposing the effective region 19 of the resist film 18.

Accordingly, for example, when the electron-beam exposure with respect to the effective region 19 of the resist film 18 starts at the inner peripheral edge of the first region E1 and finishes at the outer peripheral edge of the third region E3, the start point Ps of the electron-beam exposure exists on the inner peripheral edge of the first region E1, and the finish point Pe of the electron-beam exposure exists on the outer peripheral edge of the third region E3 in the radial direction of the substrate 4.

Therefore, when the exposure intensity distribution at the incident point of the electron beam is integrated by EID (Exposure Intensity Distribution) function, which is represented as a function of distance from the incident point of the electron beam, the magnitude relationship of an energy accumulation amount K1 in the first region E1, an energy accumulation amount K2 in the second region E2, and an energy accumulation amount K3 in the third region E3 is represented as “K1, K3<K2”. Also, the energy accumulation amount K1 in the first region E1 and the energy accumulation amount K3 in the third region E3 is approximately equal (K1 is approximately equal to K3).

The reason is as follows.

First, the case is assumed where there exists a point to be exposed (hereinafter referred to as “exposure target point”) on one line that defines the radius of the substrate 4, and there exists the aforementioned backward scattering circle at a position including the exposure target point. In this case, when the substrate 4 rotates, in this respect, the exposure target point is displaced in the rotational direction of the substrate 4. Accordingly, every time the substrate 4 makes one rotation, the exposure target point traverses the backward scattering circle one time in the rotational direction of the substrate 4.

In this time, when the exposure target point is displaced only in one step based on the drive of linear motion stage 15 in the radial direction of the substrate 4, and in accordance with this, the position of the exposure target point that traverses the backward scattering circle is displaced. Then, the exposure target point traverses the backward scattering circle several times until the exposure target point enters the backward scattering circle from one end and exits the circle from the other end in the radial direction of the substrate 4. In this case, the number of times the exposure target point traverses the backward scattering circle is small in the case where there exists the exposure target point in the first region E1 and the third region E3, compared with the case where there exists the exposure target point in the second region E2.

This is because, regarding the second region E2, even when the exposure target point exists in any position in the second region E2, the exposure target point traverses “diameter portion” of the backward scattering circle in the radial direction of the substrate 4, whereas, for example, when the exposure target point exists in the inner peripheral edge of the first region E1, or when the exposure target point exists in the outer peripheral edge of the third region E3, each exposure target point only traverses “radius portion” of the backward scattering circle in the radial direction of the substrate 4.

Based on this reason, in view of the influence on the backward scattering, the number of scattered electrons incident on the exposure target point that exists on the inner peripheral edge of the first region E1 or on the outer peripheral edge of the third region E3 is respectively less than the number of scattered electrons incident on the exposure target point that exists on an arbitrary position of the second region E2.

Accordingly, when there exists the exposure target point on the inner peripheral edge of the first region E1 or on the outer peripheral edge of the third region E3, the energy accumulation amount applied to the exposure target point according to the incidence of backward scattered electrons is represented as Ha, and when there exists the exposure target point on the arbitrary position of the second region E2, the energy accumulation amount applied to the exposure target point according to the incidence of backward scattered electrons is represented as Hb, the relationship between the energy accumulation amounts is represented as “Ha<Hb”.

Also, in the first region E1, as the position of the exposure target point comes closer to the second region E2 (that is, closer to the outer peripheral side) in the radial direction of the substrate 4, the number of times the exposure target point traverses the backward scattering circle in the rotational direction of the substrate 4 increases. Accordingly, in the first region E1, the closer a portion comes to the second region E2 in the radial direction of the substrate 4, the larger the energy accumulation amount provided by the incidence of backward scattered electrons becomes.

Similarly, in the third region E3, as the position of the exposure target point comes closer to the second region E2 (that is, closer to the inner peripheral side) in the radial direction of the substrate 4, the number of times the exposure target point traverses the backward scattering circle in the rotational direction of the substrate 4 increases. Accordingly, in the third region E3, the closer a portion comes to the second region E2 in the radial direction of the substrate 4, the larger the energy accumulation amount provided by the incidence of backward scattered electrons becomes.

Consequently, when the first region E1 is exposed, the rotational speed of the substrate 4 is varied on the condition where the linear speed is lower than the linear speed of the substrate 4 that is applied to the second region E2. Compared with a case where the constitution of the present invention is not adopted, a difference between the energy accumulation amounts due to the backward scattering can be reduced in the first region E1 and the second region E2.

Also, when the third region E3 is exposed, the rotational speed of the substrate 4 is varied on the condition where the linear speed is lower than the linear speed of the substrate 4 that is applied to the second region E2. Compared with the case where the constitution of the present invention is not adopted, the difference between the energy accumulation amounts due to the backward scattering can be reduced in the second region E2 and the third region E3.

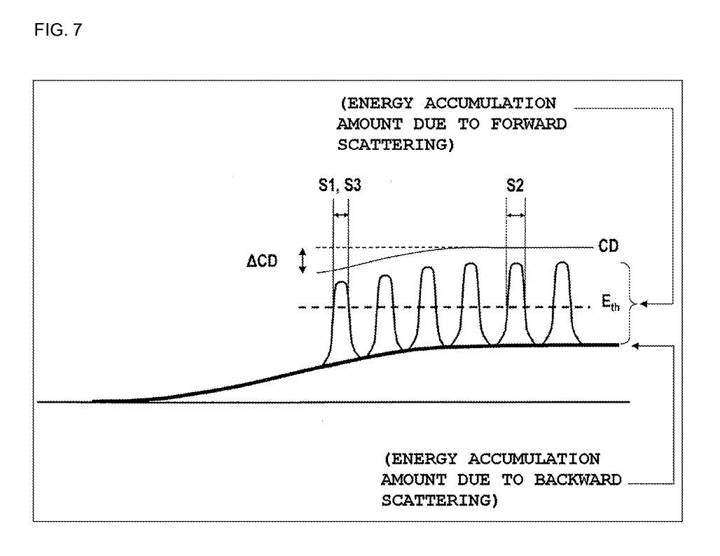

Thus, the difference between the energy accumulation amounts due to the backward scattering can be reduced in the three regions (E1, E2, and E3) that divide the effective region 19 of the resist film 18. As is described above, when the rotational speed of the substrate 4 is varied, the linear speed in the first region E1 and the third region E3 is each lower than that of the second region E2, whereby the energy accumulation amount due to the forward scattering is actually increased. For example, FIG. 7 shows the case where this is taken into consideration. In FIG. 7, when a threshold level of the energy accumulation amount required to solubilize the resist of the resists film 18 by exposure is represented as “Eth”, and error in dimensions of patterns caused by the difference among the energy accumulation amounts due to the backward scattering is represented as ΔCD, it is preferable that the rotational speed of the substrate 4 be variably controlled based on the following condition. That is, when a degree of influence on the energy accumulation amount due to the backward scattering is gradually reduced in the first region E1 (or the third region E3), and the distribution of exposure energy amount of the forward scattering, which is added to the degree, is represented like a Gaussian distribution as shown in the graph, the rotational speed of the substrate 4 is varied in such a manner that the widths (S1, S2, and S3) on the threshold level Eth of the Gaussian distribution become equal in all the regions E1, E2, and E3. That is, the rotational speed of the substrate 4 is variably controlled in such a manner that the sum of the energy accumulation amount due to the forward scattering and the energy accumulation amount due to the backward scattering becomes equal in all the regions E1, E2, and E3. This control achieves the uniformity of the energy accumulation amount across the whole area of the effective region 19 of the resist film 18. Accordingly, the variation in dimensions of patterns obtained by the development process after exposure is further reduced. In view of the influence of the forward scattering as described before, the variation in dimensions of pattern can be restrained, compared with the correction of the reciprocal proximity effect for which only the backward scattering is considered.

Incidentally, the exposure intensity distribution at the incident point of the electron beam is often represented by two Gaussian distributions made up of the forward scattering and the backward scattering but is represented in a form in which many Gaussian distributions are synthesized in view of other influence. There has been known that a fogging effect also forms a Gaussian distribution having a large diameter of the scattering. Accordingly, in the case of approximation of the exposure intensity distribution, a triple Gaussian distribution whose form is made up of three synthesized Gaussian distributions, a multi-Gaussian distribution whose form is made up of multi synthesized Gaussian distributions, or Monte Carlo simulation should be applied to the approximation so as to correct a proximity effect with high precision, rather than being approximated merely by the double Gaussian distribution in which the Gaussian distribution of the forward scattering and the Gaussian distribution of the backward scattering are synthesized. Convolution integral of these distributions and the exposure patterns is calculated with a calculator, whereby carrying out the correction of the proximity effect with high precision.

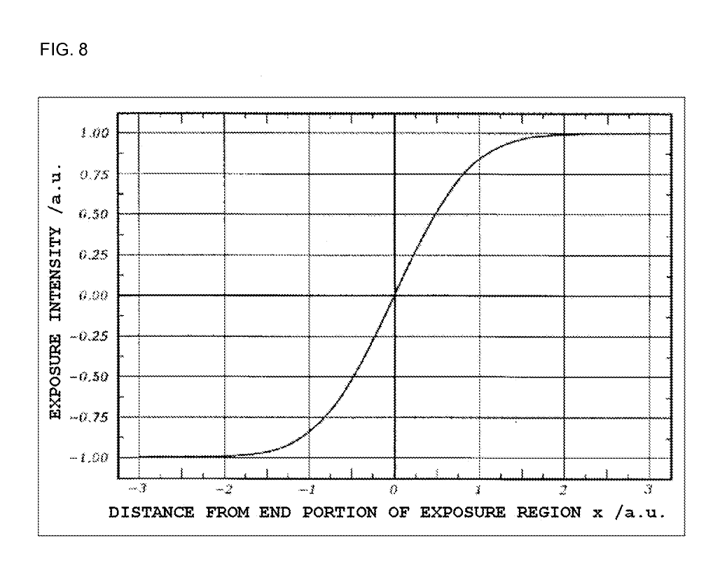

Also, it is preferable that the following constitution be adopted in order to reduce the difference among the energy accumulation amounts due to the backward scattering. That is, regarding the first region E1, the rotational speed of the substrate 4 is varied in such a manner that the difference of rotational speed of the substrate 4 that is applied in both regions increases as the irradiation position of the electron beam moves away from the second region E2, so that the difference between the energy accumulation amounts due to the backward scattering can effectively be cancelled in the first region E1 and the second region E2. This is evident in the result of the integration from minus infinity to plus infinity by substituting r with x in the aforementioned formula (Formula 1). This can be obtained with an error function. In FIG. 8, a lateral axis represents a distance x from the end portion of the exposure region, which shows the variation in exposure intensity in the vicinity of the end portion of the exposure region (x=0). As is evident in the graph, the closer the exposure region comes to the end portion, the lower the exposure intensity becomes, compared with that of the central portion. The lower exposure intensity corresponds to a smaller energy accumulation amount, it is preferable that the rotational speed of the substrate be controlled in such a manner that the linear speed is lower as the region is nearer to its end.

Similarly, regarding the third region E3, the rotational speed of the substrate 4 is varied in such a manner that the difference between the rotational speeds of the substrate 4 that are applied in both regions increases as the irradiation position of the electron beam moves away from the second region E2, so that the difference between the energy accumulation amounts due to the backward scattering can effectively be cancelled in the third region E3 and the second region E2.

Also, the influence of the backward scattering is extended to a range of the dimension corresponding to the diameter of the backward scattering each from the start point and the finish point of the electron-beam exposure. Accordingly, regarding the first region E1, the reciprocal proximity effect due to the backward scattering, which is generated on the inner peripheral side of the substrate 4, can appropriately be corrected by specifying the dimensions of the first region E1 with a dimension corresponding to the diameter of the backward scattering from the inner peripheral edge of the effective region 19 of the resist film 18.

Also, regarding the third region E3, the reciprocal proximity effect due to the backward scattering, which is generated on the outer peripheral side of the substrate 4, can appropriately be corrected by specifying the dimensions of the third region E3 with a dimension corresponding to the diameter of the backward scattering from the outer peripheral edge of the effective region 19 of the resist film 18.

### 6. Other Embodiments

It is noted that the technical scope of the prevent invention is not limited to the embodiments described above, and embodiments having various variations and modifications can be included within the scope of leading specific effects obtained through the constitutional requirements of the invention and its combination.

For example, in the radial direction of the substrate 4, the electron-beam exposure may be directed from the inner peripheral side to the outer peripheral side of the substrate 4, and conversely, may be directed from the outer peripheral side to the inner peripheral side of the substrate 4. Also, the three regions that divide the effective region 19 of the resist film 18 may be exposed in an arbitrary order. That is, when the embodiments of the present invention are executed, the order of the electron-beam exposure with respect to the effective region 19 of the resist film 18 can arbitrarily be varied. Herein, it is presupposed that uniform patterns in all the regions in the effective region 19 (in other words, patterns on which pattern density is uniform), for example, line-and-space patterns having a uniform ratio, are drawn. However, when patterns to be drawn are different in the effective region 19 (in other words, pattern density is different), for example, even if a line-and-space pattern having a different ratio, a line-and-space pattern having different dimensions, or a pattern other than the line-and-space pattern is applied, it is possible to correct the proximity effect with the same method. That is, the region to be divided may be divided into three or more. In this case, for example, when there exist a region where the density of patterns is relatively high and a region where the density of patterns is relatively low on the main plane of the substrate 4, the rotational speed of the substrate may be varied for each pattern based on the same method of the aforementioned embodiment.

In view of major concept, the present invention may be such that, when the exposure is carried out on the condition that the linear speed of the substrate at the irradiation position of the electron beam is kept constant while the rotational speed of the substrate is varied, in a region where the amount of exposure is larger than a prescribed amount of exposure, and in a region where the amount of exposure is smaller than a prescribed amount of exposure, the rotational speeds of the substrate may each be varied as follows.

That is, in the region where the amount of exposure is larger than the prescribed amount of exposure, the rotational speed of the substrate is varied in such a manner that the linear speed of the substrate increases, compared with the case where the exposure is carried out on the condition that the linear speed of the substrate at the irradiation position of the electron beam is kept constant while the rotational speed of the substrate is varied. In this case, it is necessary to increase the beam current in such a manner as to form desired dimensions in Eth.

Also, in the region where the amount of exposure is smaller than the prescribed amount of exposure, the rotational speed of the substrate is varied in such a manner that the linear speed of the substrate decreases, compared with the case where the exposure is carried out on the condition that the linear speed of the substrate at the irradiation position of the electron beam is kept constant while the rotational speed of the substrate is varied.

In this case, by “prescribed amount of exposure” is meant an amount of exposure set in advance as a reference when the exposure is carried out on the condition that the linear speed of the substrate at the irradiation position of the electron beam is kept constant while the rotational speed of the substrate is varied. That is, the energy accumulation amount to form desired dimensions in Eth is meant. Specifically, “prescribed amount of exposure” is set in accordance with the amount of exposure obtained in a region where the influence of the backward scattering is saturated when the exposure is carried out on the condition that the linear speed of the substrate at the irradiation position of the electron beam is kept constant while the rotational speed of the substrate is varied. Incidentally, according to the aforementioned embodiments, the amount of exposure obtained in the second region E2 corresponds to “prescribed amount of exposure”.

The rotational speed of the substrate is varied on this condition, so that the variation in dimensions of patterns due to the proximity effect of the backward scattered electrons can be suppressed both in the region where the amount of exposure is larger than the prescribed amount of exposure and the region where the amount of exposure is smaller than the prescribed amount of exposure.

Also, in the aforementioned embodiments, as one example of the moving means, the linear motion stage 15 on which the rotation stage 14 is mounted has been exemplified. However, the embodiments are not limited to this but, for example, a means for moving the electron-beam generating portion 2 and the electron-beam control system 3 may be applied. That is, the moving means for moving the irradiation position of the electron beam on the one main plane of the substrate 4 in the direction parallel to the radial direction of the substrate 4 may be configured to move the side of the substrate 4, the side of the electron beam, or both sides. Also, the movement of the electron beam may be carried out by deflecting the electron beam.

Also, the electron-beam exposure apparatus and electron-beam exposure method adopted in the aforementioned embodiments can respectively be applied to a manufacturing apparatus and a manufacturing method of substrates (master disc, stamper, and the like) used in a DTR technology, and the manufacturing apparatus and the manufacturing method can be extracted as one mode of the present invention.

### DESCRIPTION OF THE REFERENCE NUMERAL

1 Electron-beam exposure apparatus
4 Substrate
14 Rotation stage
15 Linear motion stage
16 Rotation stage control portion
17 Linear motion stage control portion
18 Resist film
19 Effective region
E1 First region
E2 Second region
E3 Third region

1. An electron-beam exposure method, comprising:
dividing an effective region of the light-sensitive film to be exposed in one main plane of the substrate in a radial direction of the substrate, into at least a first region, and a second region adjacent to the first region and provided at more outer peripheral side of the substrate than the first region, and a third region adjacent to the second region and provided at more outer peripheral side of the substrate than the second region;
varying a rotational speed of the substrate during electron beam exposure of the second region, under a condition that a linear speed of the substrate is kept to be constant at an irradiation position of the electron beam so that exposure intensity distributions calculated using two or more Gaussian distributions are the same in all of the first to third regions; and
varying the rotational speed of the substrate during electron beam exposure of the first region and the third region, under a condition that the linear speed of the substrate is set to be slower respectively than the linear speed used in the second region,
during exposure of a light-sensitive film of the substrate by irradiation of the electron beam by rotating the substrate having the light-sensitive film formed on one main plane thereof, and moving the irradiation position of the electron beam in a direction parallel to a radial direction of the substrate on one main plane of the substrate.

2. The electron beam exposure method according to claim 1, comprising:
varying the rotational speed of the substrate during electron beam exposure of the second region, under a condition that the linear speed of the substrate is kept to be constant at the irradiation position of the electron beam; and
varying the rotational speed of the substrate during electron beam exposure of the first region and the third region, under a condition that the linear speed of the substrate is set to be slower respectively than the linear speed used in the second region,
wherein widths of the Gaussian distribution at a level of a threshold value of an energy accumulation amount required for exposing the light-sensitive film, are the same in all of the first to third regions, when the accumulation amount of an exposure energy accumulated on the light-sensitive film by an irradiation of the electron beam is expressed by adding the Gaussian distribution indicating the energy accumulation amount by forward scattering, to a distribution indicating the energy accumulation amount by backward scattering.

3. The electron-beam exposure method according to claim 2,
wherein the rotational speed of the substrate is varied during electron beam exposure of the first region, at a variation rate smaller than a variation rate of the rotational speed of the substrate used in the second region when the irradiation position of the electron beam is moved in a direction parallel to a radial direction of the substrate.

4. The electron-beam exposure method according to claim 2, wherein the rotational speed of the substrate is varied during electron beam exposure of the third region, at a variation rate larger than a variation rate of the rotational speed of the substrate used in the second region when the irradiation position of the electron beam is moved in a direction parallel to a radial direction of the substrate.

5. The electron-beam exposure method according to claim 3,
wherein, the rotational speed of the substrate is varied so that a difference from the rotational speed of the substrate used in the second region becomes larger, as the irradiation position of the electron beam is moved away from the second region, during exposure of the first region.

6. The electron-beam exposure method according to claim 4,
wherein, the rotational speed of the substrate is varied so that a difference from the rotational speed of the substrate used in the second region becomes larger, as the irradiation position of the electron beam is moved away from the second region, during exposure of the third region.

7. The electron-beam exposure method according to claim 2,
wherein the first region is a region specified by a dimension corresponding to a diameter of backward scattering of the electron beam from an inner peripheral edge of the effective region of the light-sensitive film.

8. The electron-beam exposure method according to claim 2,
wherein the third region is a region specified by a dimension corresponding to a diameter of backward scattering of the electron beam from an outer peripheral edge of the effective region of the light-sensitive film.

9. An electron beam exposure system, comprising:
a rotation unit configured to rotate the substrate while supporting the substrate having a light-sensitive film formed on its one main plane;
a moving unit configured to move an irradiation position of electron beam on the main plane of the substrate supported by the rotation unit, in a direction parallel to a radial direction of the substrate; and
a rotation controller configured to control a drive of the rotation unit so as to
divide an effective region of the light-sensitive film to be exposed in one main plane of the substrate in a radial direction of the substrate, into at least a first region, and a second region adjacent to the first region and provided at more outer peripheral side of the substrate than the first region, and a third region adjacent to the second region and provided at more outer peripheral side of the substrate than the second region;
vary a rotational speed of the substrate during electron beam exposure of the second region, under a condition that a linear speed of the substrate is kept to be constant at an irradiation position of the electron beam so that exposure intensity distributions calculated using two or more Gaussian distributions are the same in all of the first to third regions; and
vary the rotational speed of the substrate during electron beam exposure of the first region and the third region, under a condition that the linear speed of the substrate is set to be slower respectively than the linear speed used in the second region.

10. The electron-beam exposure apparatus according to claim 9, which is configured to
vary the rotational speed of the substrate during electron beam exposure of the second region, under a condition that the linear speed of the substrate is kept to be constant at the irradiation position of the electron beam; and
vary the rotational speed of the substrate during electron beam exposure of the first region and the third region, under a condition that the linear speed of the substrate is set to be slower respectively than the linear speed used in the second region,
wherein widths of the Gaussian distribution at a level of a threshold value of an energy accumulation amount required for exposing the light-sensitive film, are the same in all of the first to third regions, when the accumulation amount of an exposure energy accumulated on the light-sensitive film by an irradiation of the electron beam is expressed by adding the Gaussian distribution indicating the energy accumulation amount by forward scattering, to a distribution indicating the energy accumulation amount by backward scattering.
